(19) United States
(12) Patent Application Publication
(10) Pub. No.: US 2018/0012161 A1
(43) Pub. Date: Jan. 11, 2018

(54) SYSTEM AND METHOD FOR OPTIMIZING UTILIZATION OF A POPULATION OF UNDERUTILIZED PHYSICAL FACILITIES SUCH AS TOURIST FACILITIES

(71) Applicant: SPLITTY TRAVEL LTD., Yokneam Ilit (IL)

(72) Inventors: Eran SHUST, Rishon LeZion (IL); Shay HOROVITZ, Rishon LeZion (IL); Avraham WORTZEL, Rehovot (IL)

(73) Assignee: SPLITTY TRAVEL LTD., Yokneam Ilit (IL)

(21) Appl. No.: 15/539,466

(22) PCT Filed: Dec. 23, 2015
(86) PCT No.: PCT/IL15/51249

§ 371 Date: Jun. 23, 2017

Related U.S. Application Data
(60) Provisional application No. 62/097,000, filed on Dec. 26, 2014.

(51) Int. Cl. G06Q 10/06; G06Q 10/02

(52) U.S. Cl. CPC G06Q 10/06311; G06Q 10/02

(57) ABSTRACT

Provided is a system for optimizing utilization of a population of underutilized physical facilities and including a time interval splitting controller operative to communicate with some but not all of a plurality of computerized organizations, the time interval splitting controller being configured to perform certain operations when a computerized organization, from among some but not all of the plurality of computerized organizations, seeks to reserve at least one portion of at least one physical facility for a specific time interval, including using a processor for partitioning at least one specific time interval at least twice, thereby to define at least first and second partitions thereof, each partition including a sequence of sub-intervals each having a length which does not exceed the specific time interval's length.

### REFERENCE TO CO-PENDING APPLICATIONS

Priority is claimed from U.S. provisional application No. 62/097,000 filed on Dec. 26, 2014 and entitled “A Method And Apparatus For Splitting Hotel Stays”.

### FIELD OF THIS DISCLOSURE

The present invention relates to information networks and, more particularly, to a system and method for matching resources to end users who seek to utilize same.

### BACKGROUND FOR THIS DISCLOSURE

Conventional technology constituting background to certain embodiments of the present invention is described in the following publications inter alia:

US2010293011(A1) describes a system for identifying hotel availability for a stay, if there is no room available in any single hotel for the whole period of the stay. This is accomplished by a request to determine availability in various hotels. From a hotel owner's point of view this enables rooms to be made available for shorter periods than the whole period of stay hence may avoid empty rooms. From the end-user's point of view this is simply a method for finding accommodation for a given period, in multiple hotels if necessary.

The disclosures of all publications and patent documents mentioned in the specification, and of the publications and patent documents cited therein directly or indirectly, are hereby incorporated by reference. Materiality of such publications and patent documents to patentability is not conceded.

### SUMMARY OF CERTAIN EMBODIMENTS

Certain embodiments of the invention seek to provide a method and apparatus for splitting hotel stays.

When looking for a hotel stay (online or offline), a search query is provided (usually such a query contains destination, date ranges, number of nights per stay, etc.) and following such a query, the result/s address a single date range for the requested stay (usually for the same date range that was requested or a similar one). One may select a result and complete the booking process.

Certain embodiments of the invention present a method that outputs hotel stay results that each contains a split of the requested date range to several (more than one) date ranges that covers the requested date range when combined. This method can provide a less costly alternative compared to booking a single date range.

To demonstrate the unobviousness of embodiments of the invention, consider the following genuine example: On Dec. 17, 2014 a search is made for a hotel in NYC for three nights: Jan. 8-13, 2015. Using an online booking system (i.e. Google Hotel Finder, Expedia, etc), it was found that the total rate for “The Sherry-Netherland” is $5502.26 (for the cheapest room available for these days). Yet, using embodiments of the proposed invention including splitting this request into two separate requests, one for three nights (range of January 8^{th}-11^{th}) and another for two nights (range of January 11^{th}-13^{th})—the total rate for the same hotel is $4125.26—a difference of $1377.

While in the above mentioned example the split is for two different ranges, this invention is not limited to a split of two date ranges and can cover the originally requested date range with more than two date ranges.

While in the above mentioned example the split is for different date ranges of the same hotel, this invention is not limited to providing a split of ranges for the same hotel—it can also provide splits for different hotels (for different date ranges) that cover the originally requested date range when combined together.

While in the abovementioned example the split is for different date ranges of the same hotel, it is not limited to the same room type. This invention can provide a split that contains different types of rooms that cover the originally requested date range when combined together.

While in the above mentioned example the split is for different date ranges that cover together the originally requested date range exactly, this invention is not limited to providing an exact coverage of the originally requested date range, and can provide a split of several date ranges that, when combined cover a total range, may begin before or after the first date of the originally requested range, and may end before or after the ending date of the originally requested date range. This supports the case of a requester that is flexible with respect to the requested date range.

While in the abovementioned example the split is for different date ranges of one room at a time, it is not limited to providing a split for just one room at a time, and can provide splits for more than one room that cover the originally requested date range when combined together.

While in the abovementioned example the requester requested a room for a specific hotel, this invention is not limited to requesting a specific hotel, and more generic query attributes may be provided, for example, searching for all hotels in a given city for the date range, all hotels of a certain star rating, all hotels of a certain country/state, or any other destination type.

This invention is not limited to providing a single itinerary that contains the split stays, or to multiple itineraries that each contain a split of the original request for a stay.

The date range splitting method may be implemented in different ways. For example, when a user query is made for a hotel stay (for a specific hotel with specific dates or length of stay, or a city name/state name with specific dates or length of stay) and all (or a subset of all) permutations that create possible splits is computed—each split covers consecutive stays of the provided date range, i.e. for hotel stays between Sep. 1, 2014 till Sep. 6, 2014, such a service would provide various available hotel options. When provided with a length or dates of stays, the reservation is split for the entire period, into two or more possible reservations (depending on the permutation size) so that a user can choose whether to book one consecutive reservation (for the entire duration) or to book two or three, or any number of reservations (or single reservation of multiple date ranges), whose combination will match the duration of the period required.

Due to considerations of maintenance, cost effectiveness, and/or of environmental resource conservation, utilization of a physical facility is preferred to be kept high and preferred to be distributed optimally over each week, month or year.

The present invention typically includes at least the following embodiments:

### Embodiment 1

A system for optimizing utilization of a population of underutilized physical facilities managed by a corresponding population of facility processors, where utilization is allocated by each individual facility processor responsive to a stream of incoming requests to the individual facility processor from any of a plurality of computerized organizations, each request defining a time interval, each time interval including a number of time units and being associated with a value allocated by the facility processor, the system comprising:

a time interval splitting controller operative to communicate with some but not all of the plurality of computerized organizations, the time interval splitting controller being configured to at least once perform the following operations when a computerized organization, from among some but not all of the plurality of computerized organizations, seeks to reserve at least one portion of at least one physical facility for a specific time interval:
decomposition, including using a processor for partitioning the specific time interval at least twice, thereby to define at least first and second partitions thereof, each partition including a sequence of sub-intervals each having a length which does not exceed the specific time interval's length (one of the partitions may for example be the trivial partition namely partitioning the specific time interval into itself and another interval of length 0);
accessing at least one data repository to determine a characterization of each sub-interval including a value allocated thereto by at least one facility processor;
computing a first value for the first partition by summing values, accessed from the data repository, allocated respectively to sub-intervals defined by the first partition,
computing a second value for the second partition by summing values associated respectively with sub-intervals defined by the second partition,
identifying an optimal partition from among the at least first and second partitions; the optimal partition including, for at least one incoming request, N>1 sub-intervals whose combined length equals the specific time interval, and
causing the computerized organization which is associated with the time interval splitting controller to send N requests to the individual facility processor respectively defining the N sub-intervals as the respective requests' time intervals,
wherein at least one value summed in the computing operations, is associated with a sub-interval including plural time units rather than with each of the plural time units individually.

For example, a 3 night time interval might be partitioned thrice:

first partition: 1 night followed by 2 nights;

second partition: 1 night, 1 night, 1 night;

third partition: 2 nights followed by 1 night.

It is appreciated that a computerized organization may receive incoming request/s to reserve a portion of a physical facility either as a result of a spontaneous initiative of an end-user or as a result of an offer “pushed” at the end-user e.g. by a travel website. Also, a computerized organization may seek to reserve portion/s of physical facility/ies pursuant to a batch process in which, say, all possible ranges are assembled, i.e. not necessarily responsive to a specific prior user request. For example, if the computerized organization is a GDS, the GDS may have in its possession a matrix of all possible partitions stored in a cache. Generally, any large computerized organization may store interval characterization tables using caching to reduce their need to send interval characterization queries to hotels and other external organizations.

Requests may be conveyed in any suitable manner, e g manually by an end-user of a website via a computerized form, or via an API. The time interval splitting controller may communicate with computerized organizations using any suitable technology e.g. via an API.

### Embodiment 2

A system according to any of the preceding embodiments wherein each facility processor comprises a reservation system used by at least one of: a hotel; a Vacation Rental facility; an AirBnb, and a HomeAway.

Many hotel reservation systems assign a value to a particular time interval including plural consecutive days, using a daily or global (for plural days i.e.) rate which is determined by a desire to optimize utilization of resources associated with only a subset of the plural days. For example, the daily rate for all days (or global rate for the entire interval) might be determined by the last day in the time interval, e.g. out of a consideration that the cost-effectiveness of performing yet another check-out on a crowded day differs from the cost-effectiveness of performing check-out on a quiet day, and/or out of a consideration that revenue flow (hence check-outs) should be optimally distributed over months such that a check-out this month might yield a better per-day rate (for the days in question) than a check-out next month, or vice-versa. Or, the daily rate for all days (or global rate) might be determined by the first day in the time interval, out of a desire to increase utilization of certain first days in which hotel occupancy is low (such as Sundays in hotels frequented by a population of business people).

According to certain embodiments, at least one value of at least one sub-interval including plural time units in at least one partition, is associated with the time interval as a whole, and there is no value, or a different value, associated with each of the plural time units individually.

### Embodiment 3

A system according to any of the preceding embodiments wherein each time unit comprises a day.

### Embodiment 4

A system according to any of the preceding embodiments wherein the computerized organization itself comprises a “middleman” which operates responsive to a stream of incoming requests to utilize physical facilities, originating from any of a plurality of computerized organizations.

### Embodiment 5

A system according to any of the preceding embodiments wherein at least one computerized organization comprises an e-commerce website.

### Embodiment 6

A system according to any of the preceding embodiments wherein the at least one computerized organization-comprises an OTA.

### Embodiment 7

A system according to any of the preceding embodiments wherein the computerized organization comprises a wholesaler.

### Embodiment 8

A system according to any of the preceding embodiments wherein the computerized organization comprises a reseller.

### Embodiment 9

A system according to any of the preceding embodiments wherein each facility processor manages a chain, comprising a networked plurality of physical facilities.

### Embodiment 10

A system according to any of the preceding embodiments wherein the portion of a physical facility comprises at least one of: a suite; an apartment and a room.

### Embodiment 11

A method for optimizing utilization of a population of underutilized physical facilities managed by a corresponding population of facility processors, where utilization is allocated by each individual facility processor responsive to a stream of incoming requests to the individual facility processor from any of a plurality of computerized organizations, each request defining a time interval, each time interval including a number of time units and being associated with a value allocated by the facility processor, the method comprising:
using a time interval splitting controller operative to communicate with some, but not all, of the plurality of computerized organizations, to perform the following operations when a computerized organization, from among some, but not all, of the plurality of computerized organizations, and seeking to reserve at least one portion of at least one physical facility for a specific time interval;
decomposition, by partitioning the specific time interval at least twice, thereby to define at least first and second partitions thereof, each partition including a sequence of sub-intervals each having a length which does not exceed the specific time interval's length;
accessing at least one data repository to determine a characterization of each sub-interval including a value allocated thereto by at least one facility processor;
computing a first value for the first partition by summing values, accessed from the data repository, allocated respectively to sub-intervals defined by the first partition;
computing a second value for the second partition by summing values associated respectively with sub-intervals defined by the second partition;
identifying an optimal partition from among the at least first and second partitions, the optimal partition including, for at least one incoming request, N>1 sub-intervals whose combined length equals the specific time interval, and
causing the computerized organization which is associated with the time interval splitting controller to send N requests to the individual facility processor respectively defining the N sub-intervals as the respective requests' time intervals.

### Embodiment 12

A system according to any of the preceding embodiments wherein the identifying includes comparing at least the first and second values to identify as the optimal partition, a partition from among the partitions having a most desirable value using a predetermined ranking of desirability.

For example, partitions may be ranked as more or less desirable simply by their total cost. Or, partitions may be ranked by pre-configured logic taking into account components of their respective characterizations other than cost such as (using a hotel example) some or all of the following characterization components: full board vs. half board vs. bed-and-breakfast; with or without Internet; cancellation refundable or non-refundable and so forth.

### Embodiment 13

A system according to any of the preceding embodiments wherein the identifying an optimal partition comprises using a user-interface to present characterizations of each partition to an end-user, and accepting the end-user's indication of the optimal partition.

### Embodiment 14

A system according to any of the preceding embodiments wherein the physical facility comprises at least one hotel.

### Embodiment 15

A system according to any of the preceding embodiments wherein the reservation system comprises a Property Management System (PMS).

### Embodiment 16

A system according to any of the preceding embodiments wherein the reservation system comprises a Channel Management system (CMS).

### Embodiment 17

A computer program product, comprising a non-transitory tangible computer readable medium having computer readable program code embodied therein, said computer readable program code adapted to be executed to implement a method for optimizing utilization of a population of underutilized physical facilities managed by a corresponding population of facility processors, where utilization is allocated by each individual facility processor responsive to a stream of incoming requests to the individual facility processor from any of a plurality of computerized organizations, each request defining a time interval, each time interval including a number of time units and being associated with a value allocated by the facility processor, the method comprising:

using a time interval splitting controller operative to communicate with some, but not all, of the plurality of computerized organizations, to perform the following operations when a computerized organization, from among some, but not all, of the plurality of computerized organizations, and seeking to reserve at least one portion of at least one physical facility for a specific time interval;

decomposition, by partitioning the specific time interval at least twice, thereby to define at least first and second partitions thereof, each partition including a sequence of sub-intervals each having a length which does not exceed the specific time interval's length;

accessing at least one data repository to determine a characterization of each sub-interval including a value allocated thereto by at least one facility processor;

computing a first value for said first partition by summing values, accessed from said data repository, allocated respectively to sub-intervals defined by said first partition, computing a second value for said second partition by summing values associated respectively with sub-intervals defined by said second partition,

identifying an optimal partition from among said at least first and second partitions, the optimal partition including, for at least one incoming request, N>1 sub-intervals whose combined length equals said specific time interval, and

causing the computerized organization which is associated with the time interval splitting controller to send N requests to the individual facility processor respectively defining said N sub-intervals as the respective requests' time intervals.

### Embodiment 18

A system according to any of the preceding embodiments wherein the computerized organization comprises a GDS.

The following terms may be construed either in accordance with any definition thereof appearing in the prior art literature or in accordance with the specification, or as follows:

booking split: is intended to include dividing hotel bookings into two or more parts (sub-intervals or splits), each containing only some of the originally requested stay nights.

OTA (Online Travel Agency) is intended to include any online travel agency or online distribution channel: e.g. Expedia.com/Travelocity.com (in US), booking.com, TravelZoo (in France). Such agencies may be regional or international. Typically, an OTA's clients are human end-users and the OTA in turn is a client of various Global Distribution Systems (GDSs) and/or various wholesalers.

GDS is intended to include any global distribution system e.g. Amadeus, Galileo. Typically, GDS's clients are OTAs, hotels, hotel-chains, resellers or wholesalers, and the GDS may link between the OTAs and the wholesalers, resellers, hotel chains or other hotels. The GDS in turn may be a client of hotels, hotel chain/s, wholesaler/s, reseller/s and other GDS/s.

Reseller (aka Merchant): intended to include a node in an information network whose clients may include, say, OTAs, hotels, hotel-chains, GDSs or wholesalers, and which is operative to link typically between OTAs and wholesalers, GDSs or hotel chains. The reseller in turn may be a client of, say, hotels, hotel chain/s, wholesaler/s, GDS/s and/or other resellers.

Wholesaler e.g. Innstant, GoGlobal, Beds-Online. Typically, a wholesaler's clients are OTAs or GDSs. The wholesaler in turn may be a client of various hotels or hotel chains. Typically, several wholesalers operate in several countries.

Hotel chain: e.g. Sheraton. Typically operate in many countries. “Hotel” is intended more generally to include any sort of tourism facility.

Module: is intended to include any functionality which may for example be performed by suitably configured processor/s.

Middleman: is intended to include any computerized organization, such as a wholesaler, GDS, OTA, reseller configured for communicating directly or indirectly with an end-user, on the one hand, and communicating directly or indirectly with a physical facility, on the other hand. Middleman entities such as Merchants/Resellers may be configured to connect or link the wholesalers/hotels/and other GDS to OTA's and vice versa, and may even be configured to connect one GDS/Merchant/Reseller to another GDS/Merchant/Reseller. The term connection typically implies digital communication between two entities and/or a client-server relationship between the two.

Computerized organization: is intended to include any organization controlled by at least one processor.

Property Management System or PMS: is intended to include any software application operative inter alia for computerized management of hotel functions such as guest bookings and online reservations. Hotel property management systems may interface with central reservation systems and channel management systems inter alia and may maintain up to date KPI (Key Performance Indicators) of a hotel including occupancy rate. Examples: SiteMinder, GuestCentric, FastBooking.

CMS or Channel Management system: is intended to include any software tool which integrates with plural OTA/GDS's to provide a consolidated hotel channel management platform. Many online distribution channels/OTAs exist and new channels evolve frequently and each OTA typically provides hotels with its own Extranet, requiring hotels to manage multiple extranets. In view of this complexity, a CMS may provide a hotel with online channel management. One example of such online channel management system is ChannelGain.

It is appreciated that the terms defined above need not be mutually exclusive. For example, expedia.com may be regarded both as a GDS and as an OTA.

Also provided, excluding signals, is a computer program comprising computer program code means for performing any of the methods shown and described herein when said program is run on at least one computer; and a computer program product, comprising a typically non-transitory computer-usable or -readable medium e.g. non-transitory computer-usable or -readable storage medium, typically tangible, having a computer readable program code embodied therein, said computer readable program code adapted to be executed to implement any or all of the methods shown and described herein. The operations in accordance with the teachings herein may be performed by at least one computer specially constructed for the desired purposes or general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with some or all of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules shown and described herein may include any one or combination or plurality of: a server, a data processor, a memory/computer storage, a communication interface, a computer program stored in memory/computer storage. The term “process” as used above is intended to include any type of computation or manipulation or transformation of data represented as physical, e.g. electronic, phenomena which may occur or reside e.g. within registers and/or memories of at least one computer or processor. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of at least one computer/s or computing system/s, or processor/s or similar electronic computing device/s, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein.

Any suitable processor/s may be employed to compute or generate information as described herein and/or to perform functionalities described herein and/or to implement any engine, interface or other system described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

### BRIEF DESCRIPTION OF THE DRAWINGS

FIG. 1 is a system, operative in conjunction with one or more sources for data re time sub-intervals such as but not limited to API/s, data repository/ies, data provided by web scraping, Caches, and inventory/ies storing subinterval characterization data which may be pushed such as deals, which uses at least one processor for optimizing utilization of a population of underutilized physical facilities, all constructed and operative in accordance with an embodiment of the present invention.

FIG. 2 is a system which uses at least one processor for optimizing utilization of a population of underutilized physical facilities, all constructed and operative in accordance with another embodiment of the present invention.

FIG. 3 is a diagram of plural partitions of a certain time interval into sub-intervals; as shown, each partition includes a sequence of sub-intervals e.g. the last partition includes a sequence of 5 sub-intervals, each being one night long.

FIG. 4 is a diagram of a Search Process Flow operative in accordance with an embodiment of the present invention.

FIG. 5 is a diagram of a Booking Process Flow operative in accordance with an embodiment of the present invention.

FIG. 6 is a simplified flow diagram of a method for optimizing utilization of a population of underutilized physical facilities managed by a corresponding population of facility processors, wherein according to certain embodiments utilization is allocated by each individual facility processor responsive to a stream of incoming requests to the individual facility processor from any of a plurality of computerized organizations, each request defining a time interval, each time interval including a number of time units and being associated with a value allocated by the facility processor. The method of FIG. 6 includes some or all of the illustrated operations, suitably ordered e.g. as shown.

Methods and systems included in the scope of the present invention may include some (e.g. any suitable subset) or all of the functional blocks shown in the specifically illustrated implementations by way of example, in any suitable order e.g. as shown.

Computational components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Each functionality herein may be implemented in software, firmware, hardware or any combination thereof. Functionality stipulated as being software-implemented may be implemented by an equivalent hardware module and vice-versa.

Any method described herein is intended to include within the scope of the embodiments of the present invention also any software or computer program performing some or all of the method's operations, including a mobile application, platform or operating system e.g. as stored in a medium, as well as combining the computer program with a hardware device to perform some or all of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

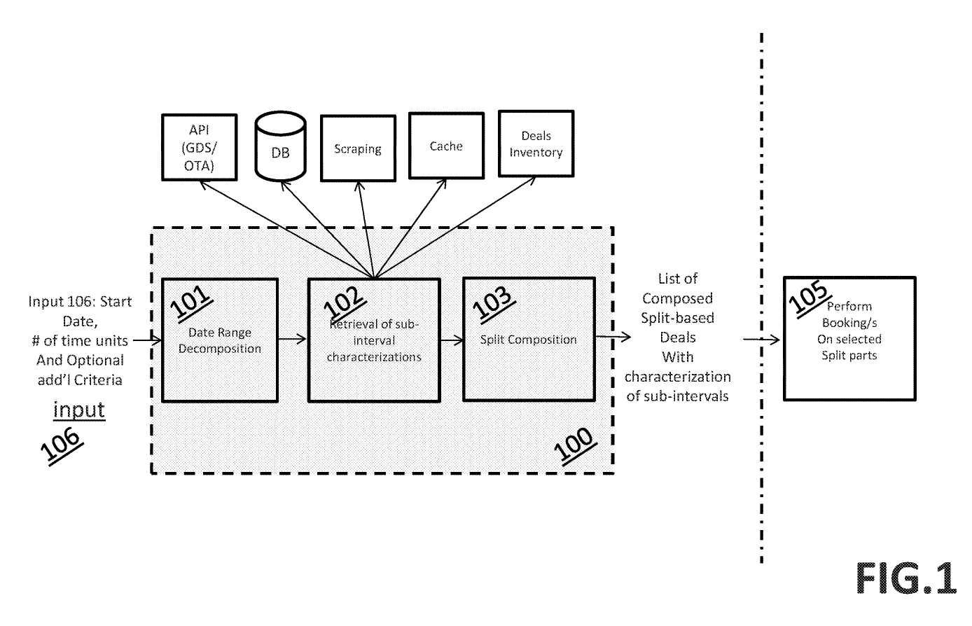

FIG. 1 shows a resource utilisation optimization system 100 in communication with resource providers via modules as shown. Typically, an end user enters a request 106 for a given period. The resource utilization optimization system contacts the providers to determine availability of hotel rooms for the period. Availability of sub-periods may be requested from each of the providers. The combination of sub-periods or days can then be combined to offer the end-user resources (e.g. hotel rooms) for the whole period.

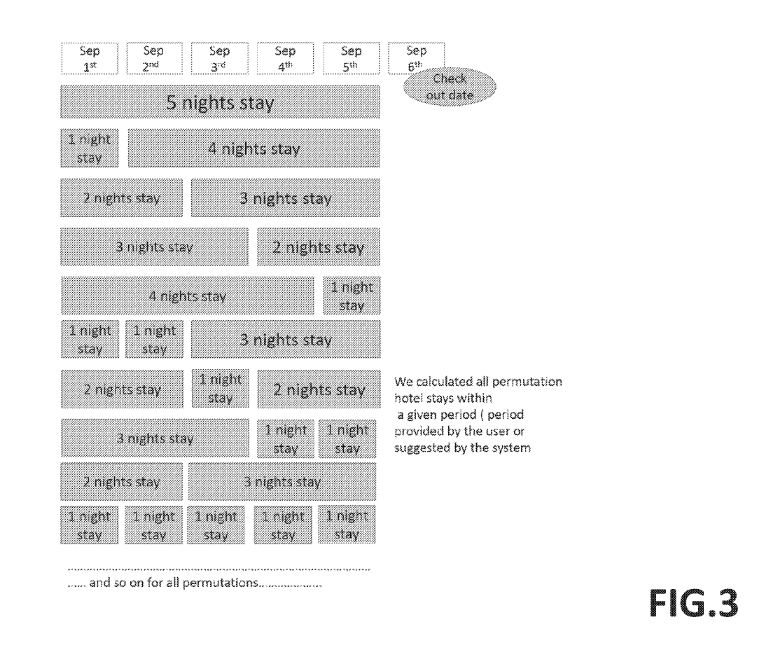

The system of FIG. 1 typically includes a Date Range Decomposition module (101) which generates a set of splits for the requested date range. The input to module 101 typically includes: arrival date and number of nights, as well as desired characterizations e.g. criteria such as: location, room types, hotel rating (stars). The output of module 101 typically includes a list of permutations of sub-ranges of dates in accordance to the required date range e.g. all possible partitions of an ordered set (array), or all possible tilings of contiguous subsequences in a sequence, or all possible k-partitions of a single dimension array of K elements where k ranges from 1 to K (K may be the number of time units e.g. nights requested to stay at the hotel). For example: given an arrival date of 1 September and a 5 night stay, partitions of the requested date range may include those illustrated in FIG. 3.

Module 101 need not necessarily generate all possible permutations of date sub ranges, and may instead generate only a portion of the set of all possible splits e.g. using random sampling of the universe of possible partitions or splits or following a policy which determines which possible splits are included in the output of module 101. According to certain embodiments, a date range decomposition policy, which may or may not be end-user selectable, and which determines whether or not to limit to providing an exact coverage of the originally requested date range, or whether to follow a “flexible date range” policy to include a split which when combined covers a total range that:

(a) begins before or after the stipulated first date or

(b) ends before or after the stipulated end-date (beginning date plus number of nights).

The output of the Date Range Decomposition module is forwarded to a sub-interval characterization data Retrieval module 102 which retrieves data characterizing sub-intervals, which may include price quotes, for each of the date ranges in each of the splits generated by the Date Range Decomposition module. The interval characterization data may be provided by from one or multiple external sources such as but not limited to a GDS, OTA, as well as hotel chains, resellers, specific hotels, Hotel Room Booking Deal Inventory (for example roomertravel.com) and/or any other computerized organization that provides on-line interval characterization e.g. price quotes for hotel room bookings. quote requests, for example, may be submitted to computerized organizations (“sources”) using any suitable technology e.g. API, protocol or query predetermined between the parties, or by applying a conventional web scraping technique to a web presence e.g. website of a sub-interval characterization source entity. Interval characterization quotes may also be retrieved from a local or remote cache or database. Any suitable web-scraping software may be employed e.g. to implement HTTP or by embedding a suitable web browser, such as Mozilla Firefox. Typically, the web scraping includes transformation of unstructured HTML-formatted data on the web into structured data for storage in a central local database or spreadsheet which facilitates analysis as described herein.

Retrieval of plural quotes may run serially or in parallel. The latter is suitable e.g. for time-bounded cases (for example, to enhance user experience it may be desired that each request for quotes be processed within only a few seconds). Retrieving quotes (aka responses to queries) serially may be suitable when coping with technological limitations such as the prevalent “look-to-book ratio” which limits the number of quote requests (looks) relative to the number of bookings. This is because serial retrieval enables use of a stopping criterion i.e. retrieval of quote n+1 occurs conditionally on results retrieved for quote n. For example, a sample batch or subset of quote requests may be sent, for which quotes are returned. The quotes are compared to a use-case specific stopping criterion (for example—“at least 10% less in cost”) and if the criterion is met, the retrieval process may stop; otherwise, an additional batch of quote requests is submitted.

Retrieved quotes each associated with a date range, are forwarded to Split Composition module (103) which composes potential split based deals by combining quotes of date ranges that were retrieved from the Sub-interval characterization Retrieval module and that together cover the originally requested hotel stay dates.

In one embodiment, the module 103 runs over the list of retrieved quotes and associated date ranges received from module 102. Module 103 may run over quotes for a first sub-interval ending at a specific day D, and then may run over quotes for a second sub-interval beginning at the next day D+1, and so on until a full cover of the originally requested stay is gained. For each cover or partition or “splitted deal”, the total price may be computed. The various covers (aka split deals, partitions) are forwarded to a client e.g. end-user or software client who is prompted to select a preferred (optimal) partition with which to continue to the booking process.

According to another embodiment, Split Composition module (103) is limited to finding partitions whose sub-ranges satisfy some condition—such as but not limited to one or more of the following conditions: all sub-ranges are in the same hotel, all sub-ranges are in the same room type, all sub-ranges have the same room number, all sub-ranges are in the same hotel chain, all sub-ranges have the same hotel rating, all sub-ranges are in hotels which are near one another to a predetermined extent, etc.

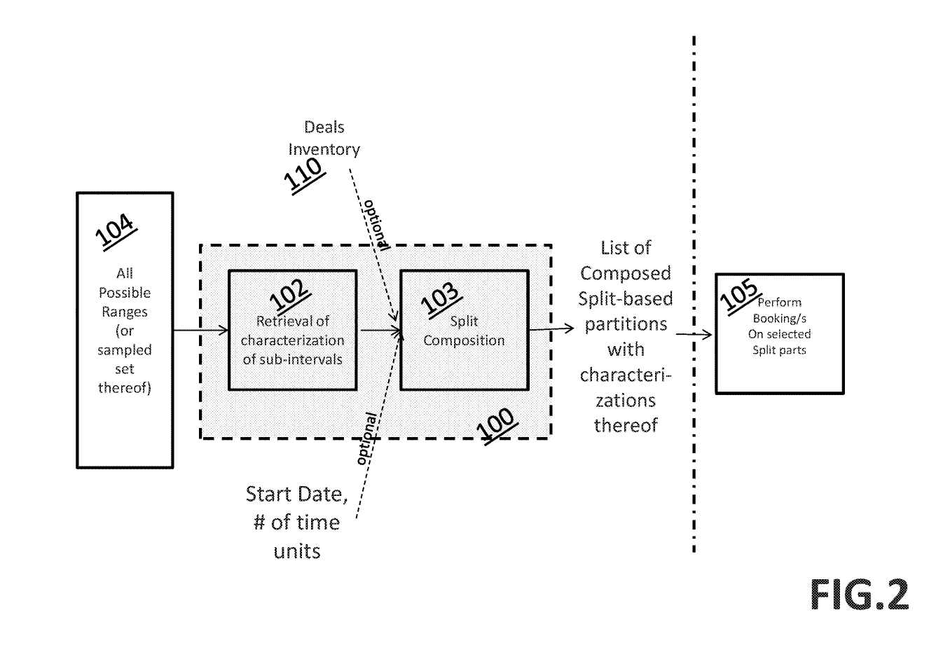

In still a further embodiment, the Date Range Decomposition module 101 is replaced by an All Possible Ranges module (104) as shown in FIG. 2. In module 104, all possible ranges are computed prior to the split composition process of module 103 (i.e. all possible intervals are handled in advance, preparatory to subsequent processing of specific given ranges of dates—rather than handling only specific intervals/ranges which could serve as sub-intervals, and only responsive to each specific given range of dates). The different covers (e.g. split deals) may be computed without any date filter or request for specific stay dates. Or, the Split Composition module (103) may receive a given request for a stay (Start date, and number of nights) which may be used to filter only potentially composed split deals or covers just for the relevant stay. In addition, a Deal Inventory 110 (e.g. Cancelon, RoomerTravel) may feed “deals” (e.g. tables or lists of plural time intervals including data characterizing each of the plural time intervals) to the Split Composition module 103, to enable the Split Composition module 103 to assemble covers that may contain split parts that are taken from the deals inventory 110. Deals typically comprise data from an external source specifying plural stay date ranges and for each such range or interval, e.g. in table form, characterization of the interval e.g. price thereof. Each entry in the table may for example comprise a date range, and some or all of: ID of the premises e.g. hotel, and characterizations such as room type, cancelation policy, price, full/half board; Internet yes/no).

An end-user or client may receive plural partitions (aka covers or split deals) from the Split Composition module (103) of FIG. 1 and may then select a single, “optimal” cover. The optimal cover is then sent to a process (105) of booking the selected split parts.

According to certain embodiments of the present invention, the booking process 105 may return a single itinerary (“Joint Booking Itinerary”) that includes multiple date ranges (aka “splits”, sub-intervals) that together cover the original requested date range (aka time interval). Alternatively, the booking process 105 may return multiple itineraries each containing a single date range or plural such ranges, that together cover the original requested date range. The booking process may employ a computerized end-user particulars form, typically only once. Each itinerary may address single or multiple suppliers (aka computerized organizations) per range of dates and/or multiple hotels and/or single or multiple room types.

It is appreciated that the systems and methods described herein may be incorporated at any layer of an information network operative for managing utilization of physical facilities. For example, conventional information networks operative for managing utilization of physical facilities may define some or all of: individual hotels e.g. as a top layer, hotel chains e.g. as a second layer, wholesalers e.g. as a third layer, GDSs e.g. as a fourth layer, OTAs e.g. as a fifth layer, and end-users e.g. at a lowest layer. At any layer from 2 onward, decomposition may be performed and N requests respectively defining said N sub-intervals may be sent upward to a layer above, however preferably, time interval splitting controller/s splitting intervals associated with a given facility, are operatively linked with only some, but not all, of the plurality of computerized organizations streaming requests to the facility.

Alternatively or in addition, the systems and methods described herein may be incorporated for various link or links of an information network that includes nodes such as but not limited to Online Travel Agencies, global distribution systems, wholesalers, reseller e.g hotel chains, and Middlemen generally, some of which are linked, however preferably, time interval splitting controller/s splitting intervals associated with a given facility, are operatively linked with only some, but not all, of the plurality of computerized organizations streaming requests to the facility.

The systems and methods described herein are suitable for any information network topology; for example, in some networks, physical facilities such as hotels and chains thereof, or rental facilities, may have wholesalers among their clients which may in turn have middlemen such as GDS's, resellers and merchants among their clients, and the middlemen may have OTAs among their clients; the OTA's may have individual human end-users among their clients. Also, various of the above categories of nodes may be each others' clients. For example, one middleman or wholesaler may be a client of another middleman or wholesaler. Or, a GDS may be a reseller's client or vice versa, a GDS may be a merchant's client or vice versa, and a reseller may be a merchant's client or vice versa. Also, links or connections described herein as indirect may alternatively be direct. For example, a physical facility e.g. chain of hotels may have a middleman as a client or vice versa, rather than the facility and the middleman being associated only via wholesalers. Similarly, a wholesaler may have an OTA as a client or vice versa, rather than the wholesaler and OTA being associated only via middlemen.

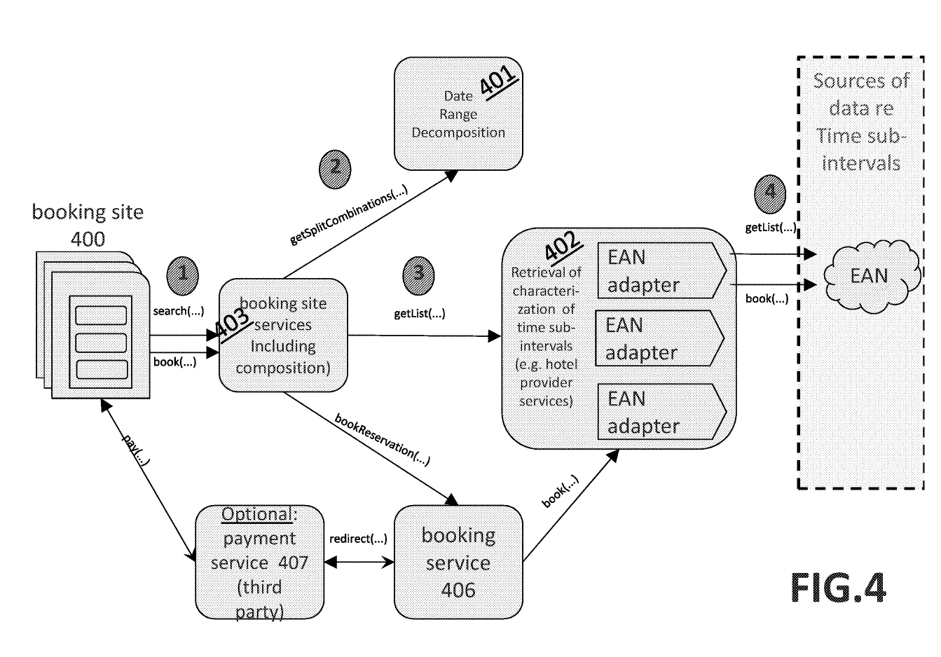

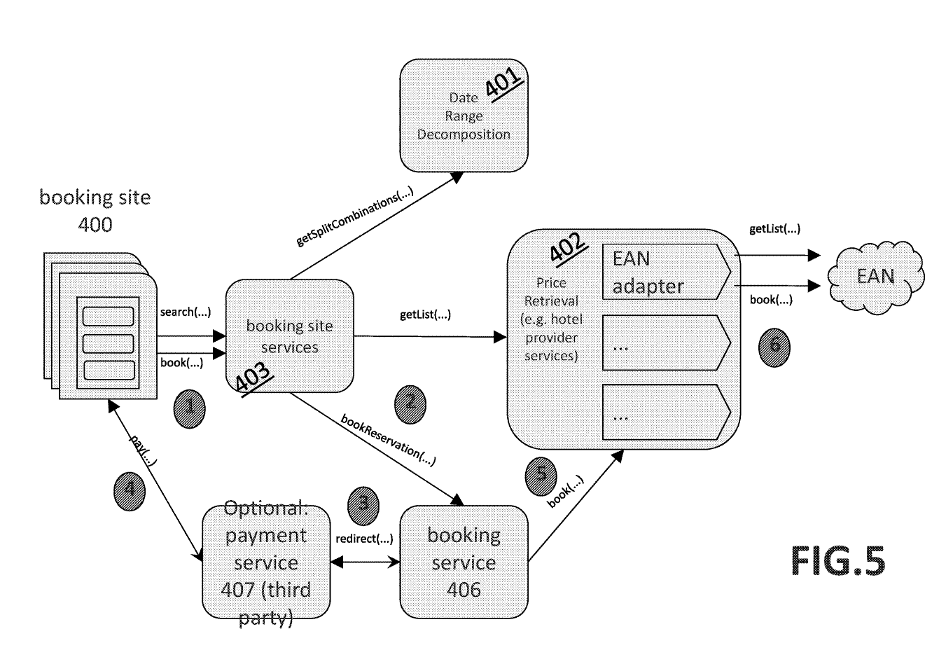

Reference is now made to FIGS. 4 and FIG. 5 which are block diagram illustrations of a system for optimizing utilization of a population of underutilized physical facilities managed by a corresponding population of facility processors. According to some embodiments of the invention the system of FIGS. 4-5 may be used for the purpose of searching and booking for hotel rooms via a booking web site 400.

The website 400 may be used as a user interface for searching for hotel rooms, booking and managing hotel room reservations. The booking web site 400 typically forwards search queries to the booking site services 403. The booking site is typically configured for using the booking site services 403 as an API for generic operations such as search, book, etc. The booking site services 403 typically uses the hotel provider characterization retrieval services 402 to search for hotel deals and typically uses the booking service 406 to book a reservation.

The Decomposition service 401 is typically configured to provide the recommended split/s e.g. responsive to a specific hotel search request. Decomposition service 401 typically determines the number of recommended split combinations based on a current query that typically includes at least date of arrival and number of days and may of course include additional parameters.

The hotel provider interval characterization retrieval services 402 manage one or more booking system adapters. Each adapter typically uses a third party API in order to perform hotel searching and booking operations. For example, the EAN adapter is responsible to cover the major Expedia Affiliate Network API endpoints, as shown.

A booking service 406 is responsible to book a new split reservation and to manage existing booking reservations. Booking service 406 typically uses the hotel provider services 402 to book a reservation from a specific hotel provider (one or more). Booking service 406 service is also typically configured to ensure/confirm the user completes the payment successfully e.g. via a third party payment service as a logical condition for booking the split reservation.

The Hotel Searching process may include any or all of the following operations, suitably ordered e.g. as shown in FIG. 4:

1. End user searches for hotel typically using suitable criteria from the booking site 400. The booking site 400 is configured for sending the end user's searching request to the booking site services 403

2. the booking site 400 is configured for using the decomposition module 401 to determine recommended splits to search

3. the booking site 400 is configured for sending the recommended split requests to the hotel provider retrieval service 402

4. the hotel provider 402 is configured for using relevant adapters, e.g. as shown, to retrieve characterizations of various sub-intervals e.g. deals defined by hotels from third party hotel providers (GDS, Wholesaler etc.), thereby to provide a “hotel searching flow result”. For example, retrieval may be implemented by any or all of the following:
a. A GDS or Wholesaler may be queried for relevant hotel deals which characterize relevant sub-intervals by using an API, for example based on CORBA, Web Services, Web APIs, REST Interface or other. Deals thus collected may be copied to a Data repository (DB) of collected deals for future query, thereby reducing the number of future queries since the DB may be used as a cache for previously retrieved deals.
b. A Data repository (DB) of collected deals may be queried for relevant hotel deals which characterize relevant sub-intervals by using a query language, for example based on SQL for relational database, Query Retrieval Commands for document based database, LINQ for Object-Relational-Mapper interface or other. The DB may be updated on occasion, e.g. upon each request to a GDS or Wholesaler by the user, or periodically, e.g. requesting deals which characterize certain sub-intervals every defined period of time.
c. A web-scraping method may be used to retrieve deals which characterize corresponding sub-intervals e.g. by firing HTTP/HTTPs requests to a web page that contains deal characterizations e.g. price quotes, extracting the characterizations from the web page and saving them in a Data repository (DB).
d. A Cache may be used for accessing recently accessed deals which characterize sub-intervals recently of interest, or frequent deals which characterize relevant sub-intervals which have frequently been of interest, within a short time, instead of either requesting the interval characterization data source with an API or querying a Data repository (DB) which may be external. The cache may be stored in memory or in disk. A Bloom filter may be employed to determine whether a particular query about a particular interval at a particular facility was asked recently and if so, to access the response thereto from cached results.
e. A Deals Inventory may be queried for ready made deals, e.g. lists or tables or sets of sub-intervals and characterizations thereof, which may have been published as special sale offers e.g. by an external Deals Inventory entity such as roomertravel.com.

The Hotel Booking process may include any or all of the following operations, suitably ordered e.g. as shown in FIG. 5:

1. an individual one of plural split hotel deals may be selected by an end-user from the hotel searching flow result generated in operation 4 of FIG. 4, in the booking site 400. The booking site 400 is configured for sending the selected deal to the booking site services 403.

2. the booking services site 403 ensures the reservation is still available, and is then operative for sending the selected deal to the booking service 406.

3. the booking service 406 may optionally redirect the end-user to a third party payment service page.

4. the payment service may be configured for charging the end-user, and may then send the payment confirmation back to the booking service 406

5. the hotel provider service 402 is configured for booking each of the split reservation parts (sub-intervals) e.g. using a suitable hotel provider service API (in one or more transactions).

6. a selected adapter in the hotel provider service is typically operative for using the third party hotel provider API to book one (or more) of the split reservation parts (sub-intervals).

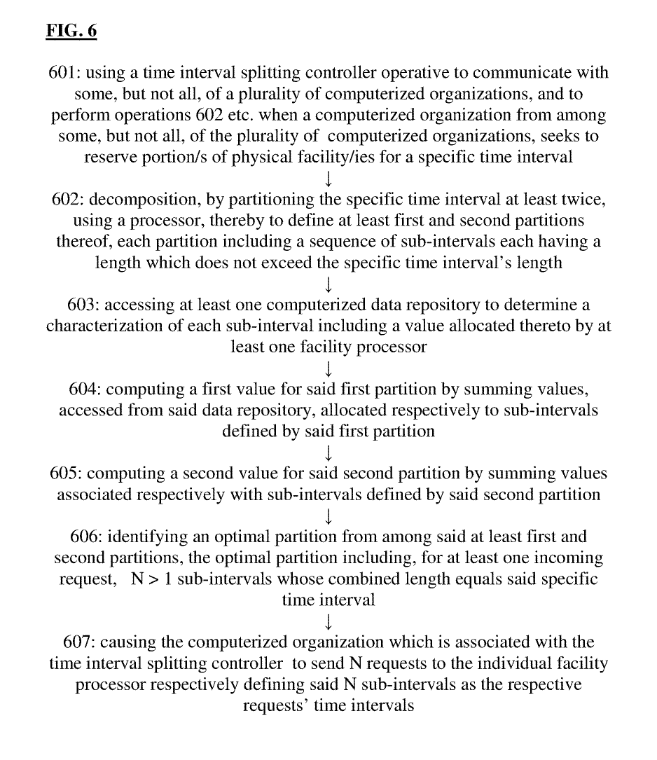

FIG. 6 is a simplified flow diagram of a method for optimizing utilization of a population of underutilized physical facilities managed by a corresponding population of facility processors, where according to certain embodiments utilization is allocated by each individual facility processor responsive to a stream of incoming requests to the individual facility processor from any of a plurality of computerized organizations, each request defining a time interval, each time interval including a number of time units and being associated with a value allocated by the facility processor. The method of FIG. 6 may for example be employed by or in conjunction with any of the apparatus of FIGS. 2-5 and typically includes some or all of the illustrated operations, suitably ordered e.g. as shown.

Operation 601: using a time interval splitting controller operative to communicate with some, but not all, of the plurality of computerized organizations, and to perform the following operations when a computerized organization, from among some, but not all, of the plurality of computerized organizations, seeks to reserve at least one portion of at least one physical facility for a specific time interval.

Operation 602: decomposition, by partitioning the specific time interval at least twice, using a processor, thereby to define at least first and second partitions thereof, each partition including a sequence of sub-intervals each having a length which does not exceed the specific time interval's length.

Operation 603: accessing at least one computerized data repository to determine a characterization of each sub-interval including a value allocated thereto by at least one facility processor

Operation 604: computing a first value for said first partition by summing values, accessed from said data repository, allocated respectively to sub-intervals defined by said first partition.

Operation 605: computing a second value for said second partition by summing values associated respectively with sub-intervals defined by said second partition.

Operation 606: identifying an optimal partition from among said at least first and second partitions, the optimal partition including, for at least one incoming request, N>1 sub-intervals whose combined length equals said specific time interval.

Operation 607: causing the computerized organization which is associated with the time interval splitting controller to send N requests to the individual facility processor respectively defining said N sub-intervals as the respective requests' time intervals.

It is appreciated that provision of a time interval splitting controller as described herein is counter-intuitive, inter alia because it would be natural to assume that attempting to “beat the system” by partitioning each of certain intervals having certain value into sub-intervals whose combined values yield an optimization, would at best be self-defeating because the facility processor would, responsively, be re-programmed by the revenue manager, thereby to re-design its value allocations to block the time interval splitting controller's ability to generate optimizations, e.g. by ensuring that any interval, under any partition, would have a combined value which equals the value of the interval itself. However, in fact, if a time interval splitting controller is associated with only some, not all, of the plurality of computerized organizations streaming requests to the facility, then game-theory type optimization by a rational facility processor will continue to cause the facility processor to allocate value in a manner which defines intervals, which, under certain partitions, have a combined value which differs from the value of the interval itself. This feature is again counter-intuitive since it would be normally be assumed that if a time interval splitting controller associated with some computerized organizations is good, then associating a time interval splitting controller with more and more computerized organizations would be even better; however simulations show that this is the case only up to a point.

According to certain embodiments, ranges may be split even within a single facility such that plural sub ranges are defined, each for a utilization of resources in a single facility e.g. each for a stay at a different sub-interval of time, but within the same hotel.

Each functionality herein may be implemented in software, firmware, hardware or any combination thereof. Functionality stipulated as being software-implemented may be implemented by an equivalent hardware module and vice-versa.

It is appreciated that terminology such as “mandatory”, “required”, “need” and “must” refer to implementation choices made within the context of a particular implementation or application described herewithin for clarity and are not intended to be limiting since in an alternative implementation, the same elements might be defined as not mandatory and not required or might even be eliminated altogether.

Components described herein as software may, alternatively, be implemented wholly or partly in hardware and/or firmware, if desired, using conventional techniques, and vice-versa. Each module or component or processor may be centralized in a single location or distributed over several locations.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations as appropriate; machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order; a computer program product comprising a computer useable medium having computer readable program code, such as executable code, having embodied therein, and/or including computer readable program code for performing any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the

Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally includes at least one of a decision, an action, a product, a service or any other information described herein that impacts, in a positive manner, a problem or objectives described herein; and (b) outputting the solution.

The system may, if desired, be implemented as a web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Some or all functionalities e.g. software functionalities shown and described herein may be deployed in a cloud environment. Clients e.g. mobile communication devices such as smartphones may be operatively associated with, but external to, the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention, including operations, which are described in the context of separate embodiments may also be provided in combination in a single embodiment. For example, a system embodiment is intended to include a corresponding process embodiment and vice versa. Also, each system embodiment is intended to include a server-centered “view” or client centered “view”, or “view” from any other node of the system, of the entire functionality of the system , computer-readable medium, apparatus, including only those functionalities performed at that server or client or node. Features may also be combined with features known in the art and particularly although not limited to those described in the Background section or in publications mentioned therein.

Conversely, features of the invention, including operations, which are described for brevity in the context of a single embodiment or in a certain order may be provided separately or in any suitable sub-combination, including with features known in the art (particularly although not limited to those described in the Background section or in publications mentioned therein) or in a different order. “e.g.” is used herein in the sense of a specific example which is not intended to be limiting. Each method may comprise some or all of the operations illustrated or described, suitably ordered e.g. as illustrated or described herein.

Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation and is not intended to be limiting.

1.-20. (canceled)

21. A system for optimizing utilization of a population of underutilized physical facilities managed by a corresponding population of facility processors, where utilization is allocated by each individual facility processor responsive to a stream of incoming requests to the individual facility processor from any of a plurality of computerized organizations, each request defining a time interval, each time interval comprising a number of time units and being associated with a value allocated by the facility processor, the system comprising:
a time interval splitting controller operative to communicate with some but not all of the plurality of computerized organizations, the time interval splitting controller being configured to at least once perform the following operations when a computerized organization, from among some but not all of the plurality of computerized organizations, seeks to reserve at least one portion of at least one physical facility for a specific time interval:
decomposition, comprising using a processor for partitioning the specific time interval at least twice, thereby to define at least first and second partitions thereof, each partition comprising a sequence of sub-intervals each having a length which does not exceed the specific time interval's length;
accessing at least one data repository to determine a characterization of each sub-interval comprising a value allocated thereto by at least one facility processor;
computing a first value for said first partition by summing values, accessed from said data repository, allocated respectively to sub-intervals defined by said first partition,
computing a second value for said second partition by summing values associated respectively with sub-intervals defined by said second partition,
identifying an optimal partition from among said at least first and second partitions; the optimal partition comprising, for at least one incoming request, N>1 sub-intervals whose combined length equals said specific time interval, and
causing the computerized organization which is associated with the time interval splitting controller to send N requests to the individual facility processor respectively defining said N sub-intervals as the respective requests' time intervals,
wherein at least one value summed in said computing operations, is associated with a sub-interval comprising plural time units rather than with each of the plural time units individually.

22. The system according to claim 21, wherein each facility processor comprises a reservation system used by at least one of: a hotel; a Vacation Rental facility; an AirBnb, and a HomeAway.

23. The system according to claim 21, wherein each time unit comprises a day.

24. The system according to claim 21, wherein the computerized organization itself comprises a “middleman” which operates responsive to a stream of incoming requests to utilize physical facilities, originating from any of a plurality of computerized organizations.

25. The system according to claim 21, wherein at least one computerized organization comprises an e-commerce website.

26. The system according to claim 25, wherein said at least one computerized organization comprises an OTA.

27. The system according to claim 21, wherein the computerized organization comprises a wholesaler.

28. The system according to claim 21, wherein the computerized organization comprises a merchant.

29. The system according to claim 21, wherein each facility processor manages a chain, comprising a networked plurality of physical facilities.

30. The system according to claim 21, wherein said portion of a physical facility comprises at least one of: a suite; an apartment and a room.

31. The system according to claim 21, wherein said identifying comprises comparing at least said first and second values to identify as the optimal partition, a partition from among said partitions having a most desirable value using a predetermined ranking of desirability.

32. The system according to claim 21, wherein said identifying an optimal partition comprises using a user-interface to present characterizations of each partition to an end-user, and accepting the end-user's indication of the optimal partition.

33. The system according to claim 21, wherein said physical facility comprises at least one hotel.

34. The system according to claim 22, wherein said reservation system comprises a Property Management System (PMS).

35. The system according to claim 22, wherein said reservation system comprises a Channel Management system (CMS).

36. A computer program product, comprising a non-transitory tangible computer readable medium having computer readable program code embodied therein, said computer readable program code adapted to be executed to implement a method for optimizing utilization of a population of underutilized physical facilities managed by a corresponding population of facility processors, where utilization is allocated by each individual facility processor responsive to a stream of incoming requests to the individual facility processor from any of a plurality of computerized organizations, each request defining a time interval, each time interval comprising a number of time units and being associated with a value allocated by the facility processor, the method comprising:
using a time interval splitting controller operative to communicate with some, but not all, of the plurality of computerized organizations, to at least once perform the following operations when a computerized organization, from among some, but not all, of the plurality of computerized organizations, and seeking to reserve at least one portion of at least one physical facility for a specific time interval;
decomposition, by partitioning the specific time interval at least twice, thereby to define at least first and second partitions thereof, each partition comprising a sequence of sub-intervals each having a length which does not exceed the specific time interval's length;
accessing at least one data repository to determine a characterization of each sub-interval comprising a value allocated thereto by at least one facility processor;
computing a first value for said first partition by summing values, accessed from said data repository, allocated respectively to sub-intervals defined by said first partition,
computing a second value for said second partition by summing values associated respectively with sub-intervals defined by said second partition,
identifying an optimal partition from among said at least first and second partitions, the optimal partition comprising, for at least one incoming request, N>1 sub-intervals whose combined length equals said specific time interval, and
causing the computerized organization which is associated with the time interval splitting controller to send N requests to the individual facility processor respectively defining said N sub-intervals as the respective requests' time intervals.

37. The system according to claim 21, wherein the computerized organization comprises a GDS.

38. The system according to claim 21, wherein said accessing comprises, at least once, determining characterizations of a time interval and of a partitioned time interval, both from a single facility.

39. A utilization optimization method comprising:
receiving, from a requester, a query seeking to reserve at least a portion of a specific facility managed by a specific facility processor, for a time interval which may be identified by a date and a number of time units; and
responsively, in at least one of the following states:
said specific facility has no vacant portions during said time interval; and/or
said query does not request characterization of said time interval as a whole,
decomposing said request, comprising using a processor for at least once partitioning said time interval thereby to define at least one sequence of sub-intervals, and
providing characterizations of each of said sub-intervals to said requester.
